(19) United States
(12) Patent Application Publication
(10) Pub. No.: US 2026/0109631 A1
(43) Pub. Date: Apr. 23, 2026

(54) ENHANCED ACTIVATED SLUDGE SYSTEM FOR REMOVING PER- AND POLYFLUOROALKYL SUBSTANCES (PFAS) FROM A FLOW OF WASTEWATER AND/OR LANDFILL LEACHATE

(71) Applicant: Emerging Compounds Treatment Technologies, Inc., North Little Rock, AR (US)

(72) Inventors: Paul Rodriguez, Scarborough, ME (US); Steven E. Woodard, Cumberland, MA (US); David Kempisty, Colorado Springs, CO (US)

(21) Appl. No.: 18/918,385

(22) Filed: Oct. 17, 2024

(51) Int. Cl. C02F 3/12; C02F 1/48; C02F 1/72; C02F 3/00; C02F 101/36; C02F 103/06

(52) U.S. Cl. CPC C02F 3/1226; C02F 1/48; C02F 1/722; C02F 3/1215; C02F 2003/003; C02F 2101/36; C02F 2103/06

(57) ABSTRACT

An enhanced activated sludge system for removing PFAS from a flow of wastewater and/or landfill leachate includes at least one bioreactor configured to receive a flow of wastewater and/or landfill leachate and configured to promote growth of biological flocs. The at least one bioreactor mixes the biological flocs with a particulate media to form biological flocs enmeshed with the particulate media which adsorb and remove a majority of the PFAS from the flow of wastewater and/or landfill leachate and outputs a flow of biological flocs enmeshed with the particulate media having the majority of PFAS adsorbed thereto and treated wastewater and/or landfill leachate having a majority of the PFAS removed. A separation subsystem separates the biological flocs enmeshed with the particulate media having the majority of PFAS adsorbed thereto from the treated wastewater and/or landfill leachate and outputs a flow of treated wastewater and/or landfill leachate having a majority of the PFAS removed.

Be it known that we, Paul Rodriguez, residing at 258 Holmes Road, Scarborough, ME 04074 and being a citizen of the United States; Steven E. Woodard, residing at 17 Homestead Lane, Cumberland, ME 04021 and being a citizen of the United States; and David Kempisty, residing at 965 Flying Eagle Place, Colorado Springs, CO 80919 and being a citizen of the United States, have invented a certain new and useful

### AN ENHANCED ACTIVATED SLUDGE SYSTEM FOR REMOVING PER- AND POLYFLUOROALKYL SUBSTANCES (PFAS) FROM A FLOW OF WASTEWATER AND/OR LANDFILL LEACHATE

of which the following is a specification:

### FIELD OF THE INVENTION

This invention relates to an enhanced activated sludge system for removing per- and polyfluoroalkyl substances (PFAS) from a flow of wastewater and/or landfill leachate.

### BACKGROUND OF THE INVENTION

Municipal and industrial wastewater treatment facilities may be used to treat wastewater and/or landfill leachate to remove contaminants, such as suspended solids, biodegradable organics, phosphorus, nitrogen, microbiological contaminants, and the like, to provide a clean effluent. The clean effluent is typically subject to strict local, state and federal regulations.

Activated sludge is one type of biological treatment process which utilizes a bioreactor(s) that contains a large population of microorganisms, the “biomass,” that consume contaminants from a flow of wastewater and/or landfill leachate to form biological “flocs.” Air may be delivered into the bioreactor(s) to provide dissolved oxygen and promote growth of these biological flocs. The mixture of wastewater and/or landfill leachate, biomass, and dissolved oxygen is commonly known as mixed liquor. The population or concentration of microorganisms in the mixed liquor is often referred to as mixed liquor suspended solids (MLSS).

After sufficient treatment in the bioreactor(s), the mixed liquor is then typically sent to a secondary clarifier where the biological flocs are separated by gravity from the mixed liquor to provide a secondary effluent and a settled sludge. The secondary effluent, or “clean” effluent, may be discharged back to the environment or processed by additional tertiary treatment processes. The majority of the settled sludge in the secondary clarifier is typically recycled back to the bioreactor by a return activated sludge subsystem. The remaining, excess sludge may be wasted from the system to control the concentration of mixed liquor suspended solids.

A membrane bioreactor (MBR) is a device or process which combines a microfiltration or ultrafiltration membrane with a bioreactor. The bioreactor includes a chamber which supports a biologically active environment where microorganisms, such as bacteria, protozoa, and the like, the “biomass”, grow and consume certain contaminants in wastewater and/or landfill leachate. In MBRs, the membrane filter(s) act as a solid-liquid separation device by retaining the biomass within the bioreactor before discharging the filtered, treated wastewater and/or landfill leachate to the environment.

One key function of the membrane filter(s) is to separate solids from a liquid. The membrane filter(s) may be located internal or external to the bioreactor.

Per- and polyfluoroalkyl substances (PFAS) are a class of man-made compounds that have been used to manufacture consumer products and industrial chemicals, including, inter alia, aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater, surface water, and wastewater and/or landfill leachate at many of these sites and refineries, including more than 100 U.S. Air Force bases.

PFAS may be used as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply.

PFAS are bio-accumulative in wildlife and humans because they typically remain in the body for extended periods of time. Laboratory PFAS exposure studies on animals have shown problems with growth and development, reproduction, and liver damage. In April 2024, the U.S. Environmental Protection Agency (EPA) issued the following strict maximum contaminant levels (MCLs) for six PFAS compounds: PFOA, PFOS, GenX, PFNA PFHxS and PFBS. Additionally, PFAS are highly soluble in water in large, dilute groundwater plumes, and have a low volatility. The vast majority of wastewaters and/or landfill leachates contain PFAS.

PFAS are very difficult to treat largely because they are extremely stable compounds which include carbon-fluorine bonds. Carbon-fluorine bonds are the strongest known covalent bonds in nature and are highly resistant to breakdown and therefore not considered decomposable.

To date, conventional wastewater treatment facilities which utilize a bioreactor(s) and a secondary clarifier(s) or membrane filters have not been used to remove PFAS from a flow of wastewater or landfill leachate because the PFAS are soluble which causes the majority of PFAS pass through the bioreactor and secondary clarifier or the membrane filter untreated. As discussed above, PFAS are highly resistant to breakdown and therefore do not biodegrade to an appreciable degree in the bioreactor.

Thus, there is a need for an enhanced activated sludge system to effectively and efficiently remove PFAS from a flow of wastewater or landfill leachate.

### BRIEF SUMMARY OF THE INVENTION

In one aspect, an enhanced activated sludge system for removing per- and polyfluoroalkyl substances (PFAS) from a flow of wastewater and/or landfill leachate is featured. The system includes at least one bioreactor configured to receive the flow wastewater and/or landfill leachate and is configured to promote growth of biological flocs. The at least one bioreactor is configured to mix the biological flocs with particulate media to form biological flocs enmeshed with the particulate media which adsorbs and removes a majority of the PFAS from the flow of wastewater and/or landfill leachate and outputs a flow of biological flocs enmeshed with the particulate media having the majority of PFAS adsorbed thereto and treated wastewater and/or landfill leachate having a majority of the PFAS removed. A separation subsystem is configured to separate the biological flocs enmeshed with the particulate media having the majority of PFAS adsorbed thereto from the treated wastewater and/or landfill leachate and outputs a flow of the treated wastewater and/or landfill leachate having a majority of the PFAS removed.

In one embodiment, the particulate media may include at least one of: granular activated carbon (GAC) reactivation waste product, powdered activated carbon (PAC) or biochar. The separation subsystem may include at least one of: a secondary clarifier, a membrane filter, or a sequencing batch reactor (SBR). At least one of the secondary clarifier, the membrane filter, or the SBR may be configured to output a waste flow of biological flocs enmeshed with particulate media having PFAS adsorbed thereto. The waste flow of biological flocs enmeshed with particulate media having PFAS adsorbed thereto may be set to control a biological population of microorganisms in the bioreactor. The waste flow biological flocs enmeshed with particulate media having PFAS adsorbed thereto may be used to create a waste product. The waste product may be directed to at least one of: a supercritical water oxidation (SCWO) or a plasma gasification subsystem configured to destroy the waste product including the biological flocs enmeshed with particulate media having the PFAS adsorbed thereto.

In another aspect, an enhanced activated sludge method for removing per- and polyfluoroalkyl substances (PFAS) from a flow of wastewater and/or landfill leachate is featured. The method includes receiving the flow of wastewater and/or landfill leachate and promoting growth of biological flocs, mixing the biological flocs with a particulate media to form biological flocs enmeshed with the particulate media which adsorb and remove a majority of the PFAS from the flow of wastewater and/or landfill leachate, outputting a flow of biological flocs enmeshed with the particulate media having the majority of PFAS adsorbed thereto and treated wastewater and/or landfill leachate having a majority of the PFAS removed, separating the biological flocs enmeshed with the particulate media having the majority of PFAS adsorbed thereto from the treated wastewater and/or landfill leachate, and outputting a flow of treated wastewater and/or landfill leachate having a majority of the PFAS removed.

In one embodiment, the particulate media may include at least one of: granular activated carbon (GAC) reactivation waste product, powdered activated carbon (PAC) or biochar. The separation step may produce a waste flow of biological flocs enmeshed with particulate media having PFAS adsorbed thereto. The waste flow of biological flocs enmeshed with the particulate media having PFAS adsorbed thereto may be set to control a biological population of microorganisms. The waste flow biological flocs enmeshed with particulate media having PFAS adsorbed thereto may be used to create a waste product. The waste product may be directed to at least one of: a supercritical water oxidation (SCWO) or a plasma gasification subsystem configured to destroy the waste product including the biological flocs enmeshed with the particulate media having the PFAS adsorbed thereto.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic block diagram showing the primary components of one example of the enhanced activated sludge system for removing per- and polyfluoroalkyl substances (PFAS) from a flow of wastewater and/or landfill leachate.

FIG. 2 show examples of biological flocs enmeshed with particulate media;

FIGS. 3A, 3B, and 3C are microscopic photographs showing examples of biological flocs enmeshed with particulate media;

FIG. 4 a schematic block diagram showing one example of the separation subsystem shown in FIG. 1;

FIG. 5 a schematic block diagram showing another example of the separation subsystem shown in FIG. 1; and

FIG. 6 is a flow chart showing the primary components of one example of the enhanced activated sludge method for removing PFAS from a flow of wastewater and/or landfill leachate.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence.

As discussed above, to date, conventional wastewater treatment facilities which utilize a bioreactor(s) and a secondary clarifier(s) or membrane filters have not been used to remove PFAS from a flow of wastewater or landfill leachate because the PFAS are water soluble and the biological flocs have limited affinity for PFAS. This causes a majority of the PFAS to pass through the bioreactor and secondary clarifier or the membrane filter untreated. As discussed above, PFAS are highly resistant to breakdown and therefore do not biodegrade to an appreciable degree in the bioreactor. Thus, there is a need for an enhanced activated sludge system to effectively and efficiently remove PFAS from a flow of wastewater or landfill leachate.

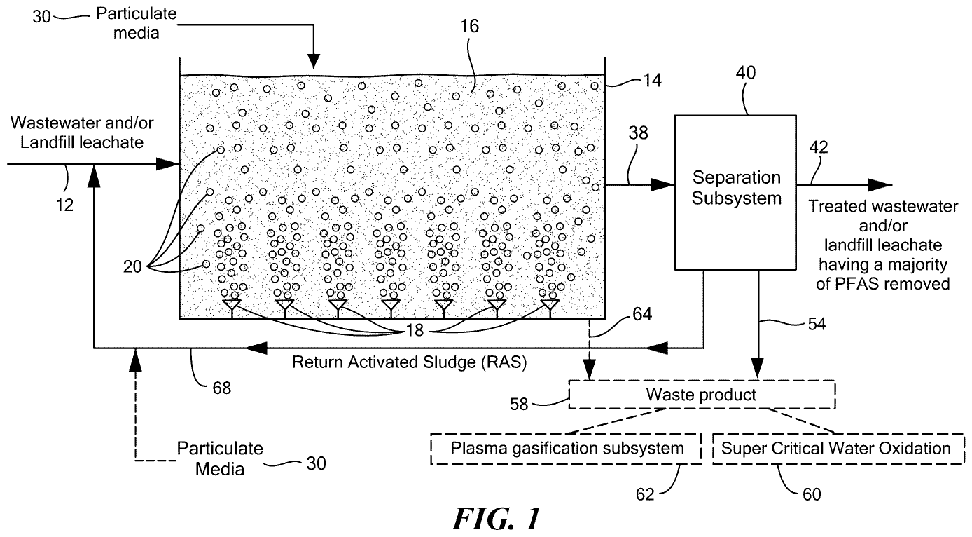

Enhanced activated sludge system 10, FIG. 1, for removing PFAS from flow 12 of wastewater and/or landfill leachate provides a solution to this problem by providing a finely ground particulate media having a high affinity for adsorbing PFAS which can effectively and efficiently be enmeshed into biological flocs. This key feature provides enhanced activated sludge system 10 with the ability to effectively and efficiently remove PFAS from a flow of wastewater and/or landfill leachate.

System 10 includes at least one bioreactor 14 which includes biomass therein, e.g., microorganisms, such as bacteria, protozoa, and the like, exemplarily indicated at 16, which promotes growth of biological flocs in bioreactor 14. Bioreactor 14 preferably includes diffuser subsystem 18 which preferably receives ambient air and injects dissolved oxygen, exemplarily indicated at 20, into bioreactor 14 to promote the growth of biological flocs.

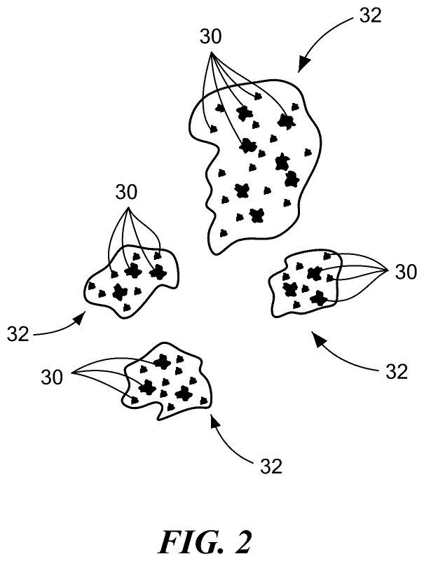

At least one bioreactor 14 mixes the biological flocs with a particulate media 30 to form biological flocs 32, exemplarily indicated in FIG. 2, enmeshed with particulate media 30 which adsorb and remove a majority of the PFAS from flow 12 of wastewater and/or landfill leachate.

Particulate media 30 may be added directly to bioreactor 14 and/or return activated sludge (RAS) line 68 and/or any other bioreactor recirculation line known to one skilled the art. RAS line 68 preferably returns biological flocs enmeshed with the particulate media 30 back to bioreactor 14.

As known by those skilled in the art, spent granular activated carbon (GAC) may be reactivated for reuse. During this process, fine particles of GAC reactivation waste product are created that are normally landfilled. These waste particles, or particulate media, happen to have a high adsorption capacity for PFAS and can be collected and sieved to form a particulate media herein referred to as GAC reactivation waste product, which may be used for removing PFAS from wastewater and/or landfill leachate. Since this GAC reactivation waste product would typically be discarded, it is therefore an inexpensive byproduct with attractive properties.

Particulate media 30 may include GAC reactivation waste product discussed above, powdered activated carbon (PAC), biochar, or similar type particulate media. As disclosed herein, biochar may be a charcoal-like substance which may be made by burning organic material from agricultural and forestry wastes, and similar type organic matter, in a reduced or starved oxygen environment typically in a process known as pyrolysis.

The size of particulate media 30 is preferably less than about 600 microns. In another example, the size of PAC 32 may be less than about 100 microns. In yet another example, the size of PAC 32 may be less than about 50 microns, e.g., about 45 microns or smaller.

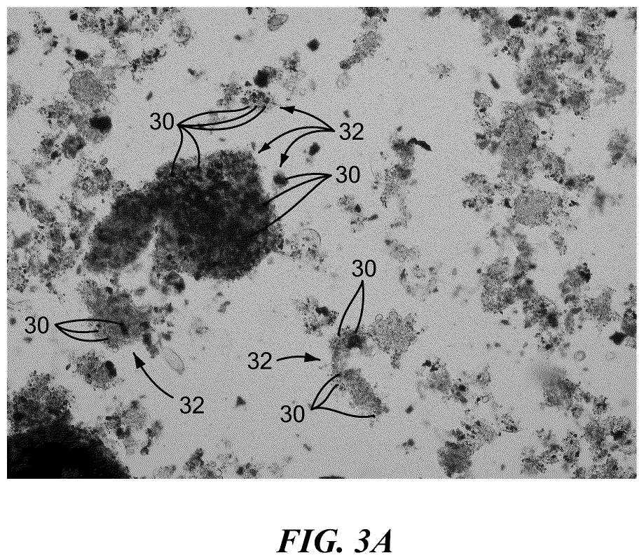

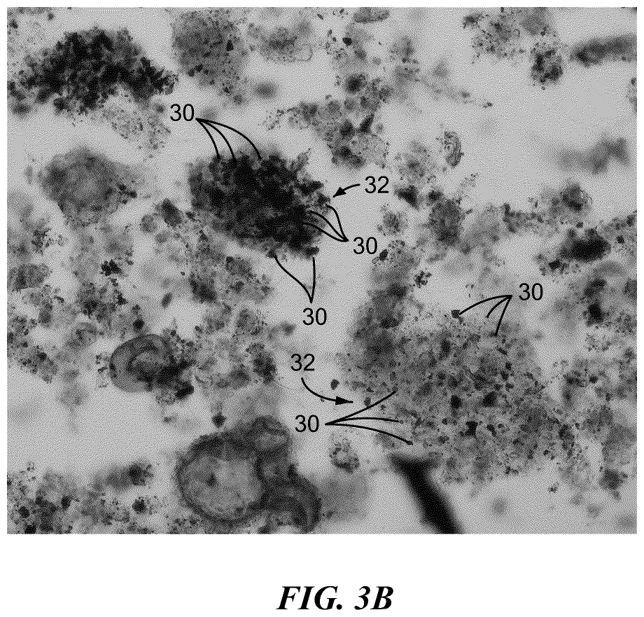

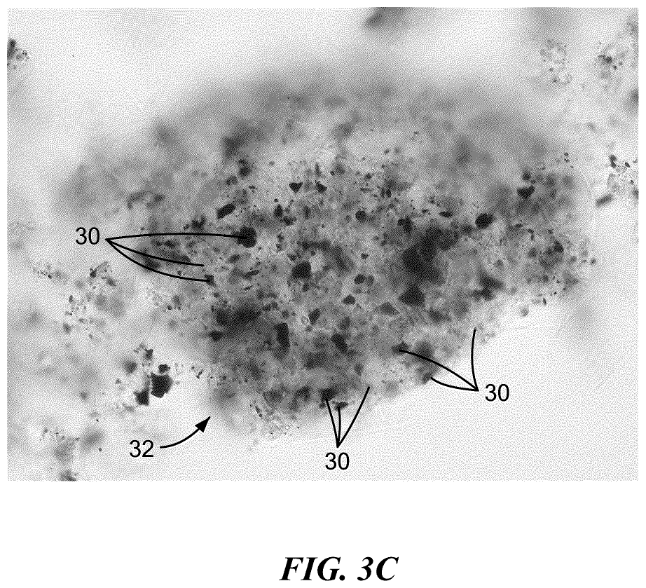

FIGS. 3A and 3B depict microscopic photographs showing in further detail examples biological flocs 32 enmeshed with particulate media 30. FIG. 3C is an enlarged microscopic photograph showing in further detail a single biological floc 32 enmeshed with particulate media 30.

At least one bioreactor preferably outputs flow 38 of biological flocs 32 enmeshed with the particulate media 30 having the majority of PFAS adsorbed thereto and treated wastewater and/or landfill leachate having a majority of the PFAS removed.

System 10 also includes separation subsystem 40, FIGS. 1, 4, and 5, which receives flow 38 and separates biological flocs 32 enmeshed with particulate media 30 having the majority of PFAS adsorbed thereto from the treated wastewater and/or landfill leachate and outputs flow 42 of treated wastewater and/or landfill leachate having a majority of the PFAS removed.

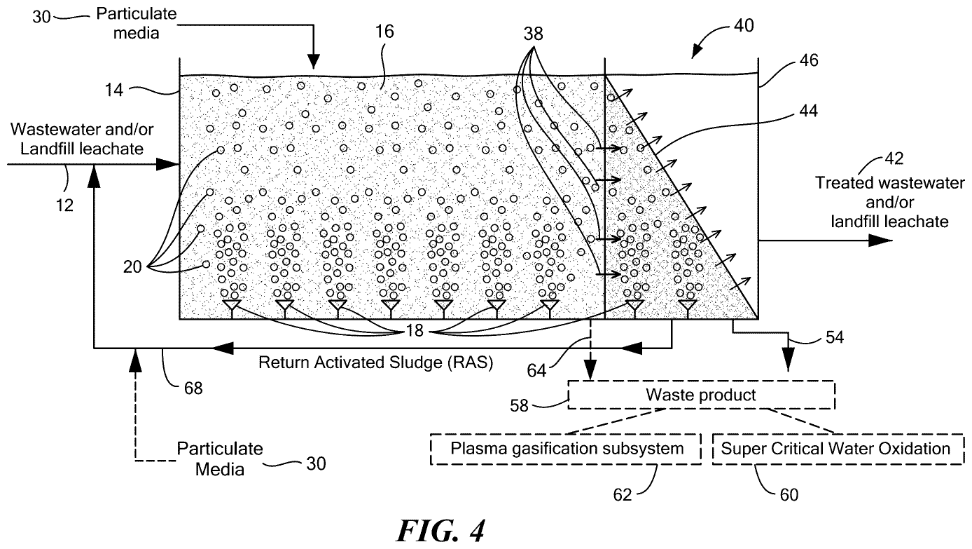

In one example, separation subsystem 40, FIG. 1, may include at least one membrane filter 44, FIG. 4, which in this example is preferably disposed in membrane tank 46 coupled to bioreactor 14 as shown. In other examples, membrane filter 44 may be located in bioreactor 14. Membrane filter 44 preferably functions as a solid-liquid separation device by retaining biomass 16 within bioreactor 14 before discharging flow 42 of filtered treated wastewater and/or landfill leachate effluent to the environment. One key function of membrane filter 44 is to separate solids from a liquid.

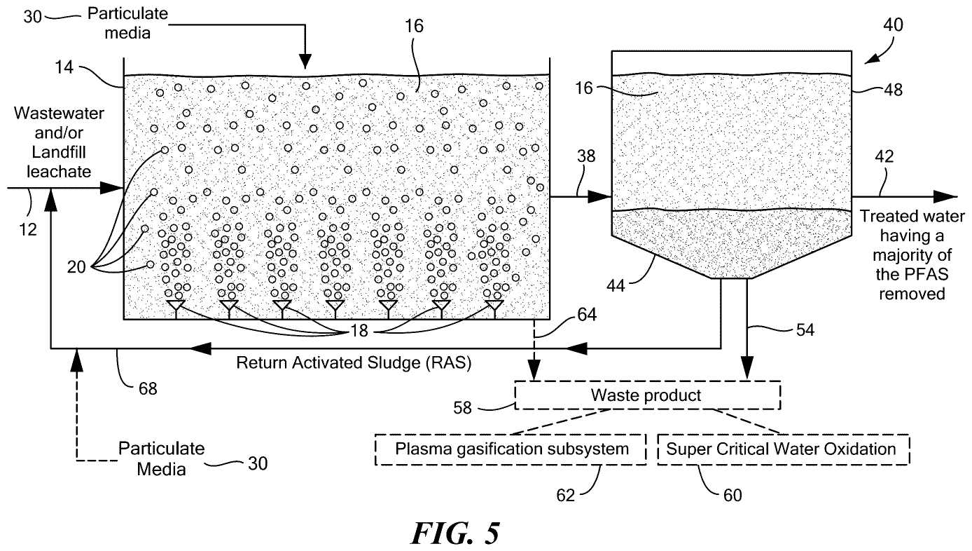

In another example, separation subsystem 40, FIG. 1, may include secondary clarifier 48, FIG. 5, which preferably separates biological flocs 32 enmeshed with particulate media 30 having a majority of the PFAS adsorbed thereto from the treated wastewater and/or landfill leachate having a majority of the PFAS removed by allowing biological flocs 32 enmeshed with particulate media 30 to settle at bottom 44 of secondary clarifier as settled thickened sludge such that secondary clarifier 48 produces flow 42 of treated wastewater and/or landfill leachate having a majority of the PFAS removed.

In yet another example, separation subsystem 40, FIG. 1, may include a sequencing batch reactor process in which diffuser subsystem 18 may be turned on for a predetermined amount of time, in one example about 4 hours to 12 hours, or similar “turn on” time known to those skilled in the art, to provide treatment and to enmesh the biological flocs with particulate media 30. Diffuser subsystem 18 is then turned off for a predetermined amount of time, in one example about 1 hours to 2 hours, or similar “turn off” time known to those skilled to separate the biological flocs 32 enmeshed with the particulate media 20 from the treated wastewater and/or landfill leachate and then decant clarified water from near the liquid surface to output flow 42 of treated wastewater and/or landfill leachate having a majority of the PFAS removed.

In one design, separation subsystem 40, FIGS. 1, 4 and 54 preferably outputs waste flow 54 of biological flocs 32 enmeshed with particulate media 30 having PFAS adsorbed thereto. Waste flow 54 may be set to control a biological population of microorganisms in biomass 16 in bioreactor 14. Waste flow 64 may also preferably be used to create waste product 58. Waste product 58 preferably includes at least biological flocs 32 enmeshed with particulate media 30 and the PFAS adsorbed thereto. In one example, waste product 58 may be directed to supercritical water oxidation (SCWO) subsystem 60 and/or plasma gasification subsystem 62, or similar type PFAS destruction subsystems, to preferably destroy waste product 58, including biological flocs 32 enmeshed with particulate media 30 and the PFAS adsorbed thereto.

Bioreactor 14 may preferably output waste flow 64 of biological flocs 32 enmeshed with particulate media 30 having PFAS adsorbed thereto. Waste flow 64 may be set to control a biological population of microorganisms in biomass 16 in bioreactor 14. Waste flow 64 may also preferably be used to create waste product 58 preferably including at least the biological flocs 32 enmeshed with particulate media 30 and the PFAS adsorbed thereto. In this example, waste product 58 is preferably destroyed as discussed above using SCWO subsystem 60 and/or plasma gasification subsystem 62, or similar type PFAS destruction subsystem.

In one example, biological flocs 32 enmeshed with particulate media 30 preferably increase treatment kinetics, thereby reducing the required hydraulic retention time and size of bioreactor 14. In addition to PFAS, biological flocs 32 enmeshed with particulate media 30 also preferably adsorbs and removes toxic organic and inorganic contaminants that are commonly contained in landfill leachate and in some wastewaters. This reduces the chronic toxicity and associated stress from the microbiological population, thereby increasing the speed with which they degrade ammonia and other contaminants of concern.

Biological flocs 32 enmeshed with particulate media 30 preferably enhance secondary clarification in secondary clarifier 48, FIG. 5. This is because biological flocs 32 enmeshed with particulate media 30 preferably have higher specific gravity than biomass 16, and biological flocs 32 enmeshed with particulate media 30 preferably settle faster. Biological flocs 32 enmeshed with particulate media 30 also preferably remove color from the wastewater and/or landfill leachate.

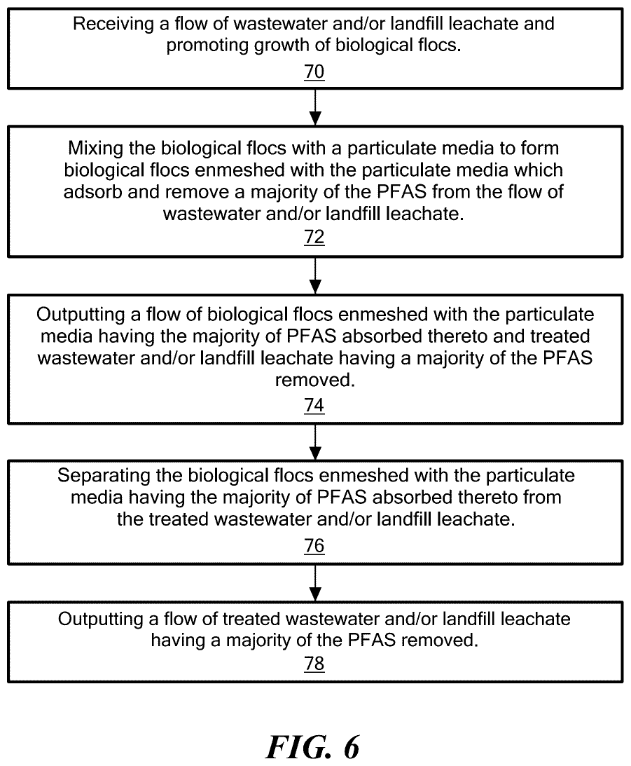

One example of the enhanced activated sludge method for removing PFAS from a flow of wastewater and/or landfill leachate, FIG. 6, includes receiving a flow of wastewater and/or landfill leachate and promoting growth of biological flocs, step 70, and mixing the biological flocs with a particulate media to form biological flocs enmeshed with the particulate media which adsorb and remove a majority of the PFAS from the flow of wastewater and/or landfill leachate, step 72. The method also includes outputting a flow of biological flocs enmeshed with the particulate media having the majority of PFAS adsorbed thereto and treated wastewater and/or landfill leachate having a majority of the PFAS removed, step 74, separating the biological flocs enmeshed with the particulate media having the majority of PFAS adsorbed thereto from the treated wastewater and/or landfill leachate, step 76, and outputting a flow of treated wastewater and/or landfill leachate having a majority of the PFAS removed, step 78.

The result is enhanced activated sludge system 10 and the method thereof efficiently and effectively removes PFAS from a flow of wastewater or landfill leachate.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. An enhanced activated sludge system for removing per- and polyfluoroalkyl substances (PFAS) from a flow of wastewater and/or landfill leachate, the system comprising:
at least one bioreactor configured to receive the flow wastewater and/or landfill leachate and configured to promote growth of biological flocs;
the at least one bioreactor configured to mix the biological flocs with particulate media to form biological flocs enmeshed with the particulate media which adsorb and remove a majority of the PFAS from the flow of wastewater and/or landfill leachate and output a flow of biological flocs enmeshed with the particulate media having the majority of PFAS adsorbed thereto and treated wastewater and/or landfill leachate having a majority of the PFAS removed; and
a separation subsystem configured to separate the biological flocs enmeshed with the particulate media having the majority of PFAS adsorbed thereto from the treated wastewater and/or landfill leachate and output a flow of the treated wastewater and/or landfill leachate having a majority of the PFAS removed.

2. The system of claim 1 in which the particulate media includes at least one of: granular activated carbon (GAC) reactivation waste product, powdered activated carbon (PAC) or biochar.

3. The system of claim 1 in which the separation subsystem includes at least one of: a secondary clarifier, a membrane filter, or a sequencing batch reactor (SBR).

4. The system of claim 3 in which at least one of the secondary clarifier, the membrane filter, or the SBR is configured to output a waste flow of biological flocs enmeshed with particulate media having PFAS adsorbed thereto.

5. The system of claim 4 in which the waste flow of biological flocs enmeshed with particulate media having PFAS adsorbed thereto is set to control a biological population of microorganisms in the bioreactor.

6. The system of claim 4 in which the waste flow biological flocs enmeshed with particulate media having PFAS adsorbed thereto is used to create a waste product.

7. The system of claim 5 in which the waste product is directed to at least one of: a supercritical water oxidation (SCWO) or a plasma gasification subsystem configured to destroy the waste product including the biological flocs enmeshed with particulate media having the PFAS adsorbed thereto.

8. An enhanced activated sludge method for removing per- and polyfluoroalkyl substances (PFAS) from a flow of wastewater and/or landfill leachate, the method comprising:
receiving the flow wastewater and/or landfill leachate and promoting growth of biological flocs;
mixing the biological flocs with a particulate media to form biological flocs enmeshed with the particulate media which adsorb and remove a majority of the PFAS from the flow of wastewater and/or landfill leachate;
outputting a flow of biological flocs enmeshed with the particulate media having the majority of PFAS adsorbed thereto and treated wastewater and/or landfill leachate having a majority of the PFAS removed;
separating the biological flocs enmeshed with the particulate media having the majority of PFAS adsorbed thereto from the treated wastewater and/or landfill leachate; and
outputting a flow of treated wastewater and/or landfill leachate having a majority of the PFAS removed.

9. The method of claim 8 in which the particulate media includes at least one of: granular activated carbon (GAC) reactivation waste product, powdered activated carbon (PAC) or biochar.

10. The method of claim 8 in which the separating step produces a waste flow of biological flocs enmeshed with particulate media having PFAS adsorbed thereto.

11. The method of claim 10 in which the waste flow of biological flocs enmeshed with the particulate media having PFAS adsorbed thereto is set to control a biological population of microorganisms.

12. The method of claim 10 in which the waste flow biological flocs enmeshed with particulate media having PFAS adsorbed thereto is used to create a waste product.

13. The method of claim 12 in which the waste product is directed to at least one of: a supercritical water oxidation (SCWO) or a plasma gasification subsystem configured to destroy the waste product including the biological flocs enmeshed with the particulate media having the PFAS adsorbed thereto.
